(19) United States
(12) Patent Application Publication
(10) Pub. No.: US 2026/0368789 A1
(43) Pub. Date: Nov. 19, 2026

(54) METHOD OF REGULATION AND DISTRIBUTION OF GOODS AND SERVICES

(71) Applicant: CODINGMOTH SRL, Modena (IT)

(72) Inventor: Davide TRUZZI, Modena (IT)

(21) Appl. No.: 19/132,393

(22) PCT Filed: Nov. 23, 2023
(86) PCT No.: PCT/IB2023/061834

§ 371 Date: May 23, 2025

(30) Foreign Application Priority Data
Nov. 24, 2022 (IT) 102022000024270

(51) Int. Cl. G06Q 30/0601; G06Q 10/02

(52) U.S. Cl. CPC G06Q 30/0609; G06Q 10/02

(57) ABSTRACT

The world of e-commerce and, more generally, the digitisation of services, are rapidly developing realities, destined to dominate most aspects of people's lives in the near future. This change involves, as a result, all civil society and the productive sectors as well as those related to communications. However, even today, in the era of Web 3.0 and the global network based on the use of machine learning and artificial intelligence applications, the process of digitization of commercial services and services aimed at the person does not keep pace with the needs of the market and society. In particular, the present invention describes an innovative method to make the management of online shopping races more streamlined and more honest for participants, avoiding problems of slowdown or overloading on sites and ensuring the maintenance of the correct order of arrival of participants.

### FIELD OF THE INVENTION

The world of e-commerce and, more generally, the digitisation of services, are rapidly developing realities, destined to dominate most aspects of people's lives in the near future. This change involves, as a result, all civil society and the productive sectors as well as those related to communications. However, even today, in the era of Web 3.0 and the global network based on the use of machine learning and artificial intelligence applications, the process of digitization of commercial services and services aimed at the person does not keep pace with the needs of the market and society. We are therefore witnessing increasingly widespread and uncontrolled phenomena, driven by the energy and raw materials crisis, which jeopardize the profitable use of the IT tool in commercial transactions and related to personal services, to name a few examples:
1) the hoarding of goods on e-commerce portals for the purpose of resale (reseller). By creating a monopoly on limited goods, an upward price effect and a constant problem of supplying the goods in question are created, where they are intercepted before being made available to potential real buyers and not to resellers.
2) The digital ticket scalping of admission tickets to public shows (concerts, sporting events, etc.) with the intention of selling them at an increased price.
3) The use of illegal software called “sniper”, which has the task of circumventing the common rules of sale on e-commerce portals. These software allow malicious users to access the goods for sale by bypassing canonical computer methods.
4) Crises and disruptions of traditional ticketing systems that, due to obsolete software architectures, are not able to withstand traffic peaks during the digital distribution of services, especially in the initial stages.
5) Services that do not always respect a precise policy in the relationship between supplier and user in terms of equal opportunities of access to the goods in question, an aspect that often makes the experience opaque during commercial exchange.

### PRIOR ART

The common problem underlying all these deleterious phenomena is the inability of IT systems dedicated to distribution to adequately manage peak requests and massive access to their software architecture. From a strictly technical point of view, the problem is the following: every request received from a server requires a minimum time to be processed and, when the workload becomes excessive for the machine, the requests cannot be processed immediately. These requests, given the inability of the system to process them and provide a response on their status, are placed in an indeterminate waiting period in which the user is not aware of the outcome of their request for access to the good/service. This “funnel” gives rise to the main problematic phenomena that affect digital distribution: 1) The rush to service. That is, the user, fearful of not being able to access the good/service, accesses the system in question at the same time as the distribution opens, contributing to the congestion of requests 2) The collapse of IT services. That is, traffic peaks on server architectures normally sized for standard traffic, when subjected to excessive workloads, can collapse IT structures connected to these (portals, sites, apps), generating problems and disruptions not only for users but also for system operators. The traditional solutions to this problem of an essentially statistical-mathematical nature are not satisfactory at the current state of the art. From an IT point of view, if you decide to parallelise incoming requests, spreading them over several queues, you cannot guarantee a service order corresponding to that of arrival. Therefore, a fundamental principle of equity and equal opportunities for regulated access to goods/services is lost, especially when they are limited in quantity or availability over a specific period of time. If instead you choose not to parallelize the system, a server overloaded with requests does not work correctly, even returning the order of arrival on a single instance, as many requests can be lost by timeout.

It is an object of the present invention to describe a method of regulation and distribution of goods and services that can guarantee a correct and precise order of a queue of requests and precisely inform the participant of his position obtained in the queue.

Yet another object of the present invention is to describe a method of regulation and distribution of goods and services that is fast and reduces waiting times for the user.

A further object of the present invention is to describe a method of regulation and distribution of goods and services that can ensure the same level of opportunity for all users.

A further object is to describe a method of regulation and distribution of goods and services by facilitating their organization in a queue when the volume of requests to participate in the queue increases considerably.

Finally, a further object is to describe a method of regulation and distribution of goods and services that can protect against illegal IT tools.

These and further objects will be clarified in depth by the description below.

### DETAILED DESCRIPTION

The method of regulation and distribution of goods and services distributed online object of the present invention brilliantly solves the aforementioned problems of the known art, in a completely advantageous and innovative way said method comprising at least one or more computer systems and including at least the phases of: PHASE 1:
creation of a one-time race t0, where a race means the procedure used to draw up the positioning for online purchase obtained by remote users who participate in it or the participants (e.g. users who try to buy a ticket for a concert) said race being characterized by:
   an identifier I or race name G;
   a time/date of the start and end Time IF;
characterized in that said method provides
   an accessibility time tx before the actual start (concept that will be better clarified later).
optionally: definition of the permits to participate, that is: race without permits (race (X) or race with permits (Y). In the event of a race with permits, the participant will have an anonymous key previously communicated. In the event of a race without permits, nothing else will be needed.
PHASE 2:
user access to the race at a time t1 where t1: t0<tx<t1<t2 and where t2 is the race start time.
opening of a first connection (authorization websocket—this websocket will be better described below) between said computer system and the participants, said websocket verifies the permissions (PU) to the specific race comprising:
sending by a participant of the identifier (I) of the race (G) to the computer system (to confirm that they participate in that race;
(optional)
sending by the participant of said anonymous identification key to the computer system in the event of a race (GY);
if the permissions are verified, the opening of a race websocket is authorized after the time (tx) at the time (t1) then before the start of the race (t2) (this websocket will be better described later), in this way the authorization websocket performs the most computationally burdensome tasks before the opening of the race socket, easing the latter's task as much as possible.
   opening of a connection between the computer system and the user called race websocket, therefore before (t2), the connection being opened in advance of the sending of the actual race information, to minimize any discrimination due to network speed and the like, ensuring simultaneous reception of all information relating to the Participants, reducing waiting times for the user. The information exchanged through the race socket with the client does not concern authorization charges, but only what is strictly necessary for the response to maximise the effectiveness of the system.

It should be noted that the advantage of introducing the t0-t1 access window, before the actual start of the race, allows all the checks prior to accessing the race itself to be spread over a longer and not resource-intensive time (parallelisable). It eliminates the need to concentrate a large amount of communications and processing at the most critical moment (the opening of the race) and allows you to limit the bytes exchanged with the race websocket to the bare minimum, thus making it able to withstand many more connections per second without the danger of crashes or slowdowns.

And still said method includes
the sending by the computer system of an electronic questionnaire to the participating user in an encrypted way that is not legible for the user at the time (t1) in order to allow all users to receive the questionnaire before the start of the race so as not to overload the system; subsequently
sending by the race websocket of a key to decrypt the electronic questionnaire at time (t1<tc<t2);
PHASE C start of the race at time (t2):
The user who answered the questionnaire sends it to the computer system;
a structure called Client Buffer will collect the information sent by the participants through the race websocket and will be recorded/stored with a known method (e.g. FIFO) to establish the ranking of the participants;
the computer system reads and processes the information (identifying of each user) and subsequently;
validation of the information or verifies that the data are complete with respect to the required requirements;
definition of the positioning list based on FIFO;
sending the positioning results simultaneously to two clickbuffer (temporary data containment structures):
the first clickbuffer will provide the data to a database for the registration of the positioning available to the system,
the second clickbuffer by means of a second dedicated (race) websocket, will provide positioning information to each participant by dividing the data flow making the management of the race fast.

Note that this questionnaire may include simple questions (e.g. a mathematical/logical/visual questionnaire);

It should be noted that, in a completely innovative and advantageous way, always in terms of guaranteeing fair access, said questionnaire must be kept secret, that is, inaccessible, until the actual start of the Race with which it is associated; for this reason, at the opening of the Race, the connected Participants may send their information following the resolution of the Questionnaire. To do this, however, they must wait for the reception and therefore the download of the image of the Questionnaire itself on the page; in addition to the times linked to the individual connections of the users, the massive request to the server that exposes the Questionnaire must also be considered, which would suffer, without being able to meet all the requests in good time. For this reason, advantageously, the Questionnaire is sent to the individual Participants sequentially a few moments before the actual opening of the Race (order of a few seconds). However, this sending is encrypted, so that it is not yet usable/viewable. In this way, the Questionnaire image, even if unusable, already resides in the Participants' devices (users' browsers); at the actual opening of the Race, what will be sent will only be the decryption key (sending a few bytes) that will allow the display of the Questionnaire itself directly from the user's device. This measure radically reduces the impact on the server and waiting times, always with a view to providing a service that is as fair and equitable as possible for end users. In a variant, the questionnaire can also be sent, in encrypted form, from ten minutes to one minute before the actual opening of the Race. In this case, a decryption key is sent, from five seconds to one second before the actual opening, which allows it to be displayed. In addition, always in a variant, the channel for sending the questionnaire can vary and be a service that returns an image such as mqtt, http.

This is essentially to minimize the possibility of malicious users developing a method of automatically generating a fraudulent response to the questionnaire. The solution is therefore innovatively to make the image of the questionnaire accessible to the user only at the moment of the start of the race through a separate submission: before the start of the race, the image of the questionnaire is sent without it being able to be displayed but in such a way that most of the weight in bits of the questionnaire can be “pre-loaded” on the participant's side and, at the time of the start of the race, the sending of a few bits for a decryption key of the questionnaire in order to allow all participants to be able to view the questionnaire without penalising waits and without the possibility of incurring in fraudulent attempts to alter the display of said questionnaire.

Construction of the ranking of the participants: a structure called Client Buffer will collect the information sent by the participants through the race websocket and will be recorded/stored with a method known in the art as FIFO (first in—first out) in detail a stack of FIFO data has as distinct characteristics:
An element inserted in the queue (in this case the Participant's information) cannot be read, nor extracted from the queue, as long as there are other elements in front of it (previously inserted). This means that any information relating to the Participants will be read sequentially, ensuring the order of arrival
In order to access (read) an item from the queue, it must be extracted from the queue; the extraction itself involves the elimination of the item from the queue, ensuring that a single Reader will have access to the data, without the possibility of duplication and/or multiple processing for that same information of the Participant. In other words, if multiple readers are listening on the same ClickBuffer, only one will have access to specific information about the Participant.
   Information reading: The information relating to the Participant is read by an appropriate service (hereinafter referred to as the Reader) which, one by one, verifies it and enriches it with other information:
validity: boolean (true/false) to indicate whether the click received is valid or not;
absolute positioning: regardless of the validity, it indicates the arrival position when sending the information for the Race in which the Participant is active.
Actual position: valued only for the Participant's valid information, it indicates the actual position obtained in the Race;
Error message: valued only for invalid Participant information, describes the reason for the rejection.
   Validation: The information of a Participant following the resolution of the Questionnaire is considered valid if:—The answer/solution given to the Questionnaire is correct;
The Race in which you participate is in the “in progress” State;
The Participant's identification token must be valid (in the case of Race Type Y);
   Positioning:
submission of validated participant information on two other ClickBuffer, then with a separation of tasks: one is used to record the results, the other to notify the Participant of the result obtained.

Also in this case in a completely innovative and advantageous way, the separation of the clickbuffer for different services allows the organizer to access a fair ranking and the participant to be able to know in real time their position in the ranking.

The current implementation of these controls, including the submission on the ClickBuffer, is always carried out sequentially to always ensure the order of arrival of the information of the Participants in the Race. The historicization of this information is performed by a dedicated service (Reader of the first ClickBuffer) which is responsible for persistently saving the ordered list of requests, then the actual placement within a database. The positioning of each Participant will therefore be available to the organizer, clearly with visibility limited to the results of the Race under their management. The second ClickBuffer is for the consumption of a further service with the purpose, as anticipated, of forwarding the results to the Participants connected to the service. By means of the open connection to the authorization websocket of the individual reference Participant, their Ranking for the Race in question is sent back to them in the form of a notification.
Websocket: Access to a Race by a Participant requires simultaneous connection to two websockets, each with a specific role:
authorization websocket: it is the first websocket to which a connection is opened, verifies the presence of the token assigned to the Participant (in the case of Race Type Y) and in general carries out the security checks necessary to continue with the actual participation in the Race itself. If the connected user passes the controls, the connection to the second websocket will be opened. The authorization websocket is also used to send notifications, as described above, and to receive the Questionnaire to be resolved;
   the second websocket, called “Race” websocket, has the sole purpose of sending the information relating to the Participants of the specific Race. The connection is opened in advance of sending the actual information, to minimize any discrimination due to network speed and the like, ensuring simultaneous reception of all information relating to the Participants.

It is clear how, in a completely new and highly advantageous way, the method of regulation and distribution of goods and services can return the order of arrival and access of participants with extreme precision. In fact, users who intend to access a commercial good/service are given real-time feedback on their position in the ranking, guaranteeing a transparent and non-frustrating experience.

The document US 2014/164126 describes a delivery method that increases the visibility of promotional products and generates new sales. The method is flexible and can be adapted to the specific needs of a company.

Therefore, in relation to the present invention, it is evident that there are no common elements as the invention does not concern a method to increase the visibility of promotional products, but rather a method to regulate access to the reservation of a product and a service by drawing up a list of users interested in said services or products. Here, therefore, it is not a “race” that presupposes a game or video game but, in the context of the invention presented, a race is a reservation request for a product or service to maintain the user access order in which they have accessed at t1 before the official start at t2 of the race, so as not to overload the servers, maintain the priority of the participants, and guarantee secure access through dedicated tokens as described above.

### BRIEF DESCRIPTION OF THE FIGURES

FIG. 1 shows in schematic form the steps characterising this method of regulation and distribution of goods and services.

### DETAILED DESCRIPTION OF THE FIGURES

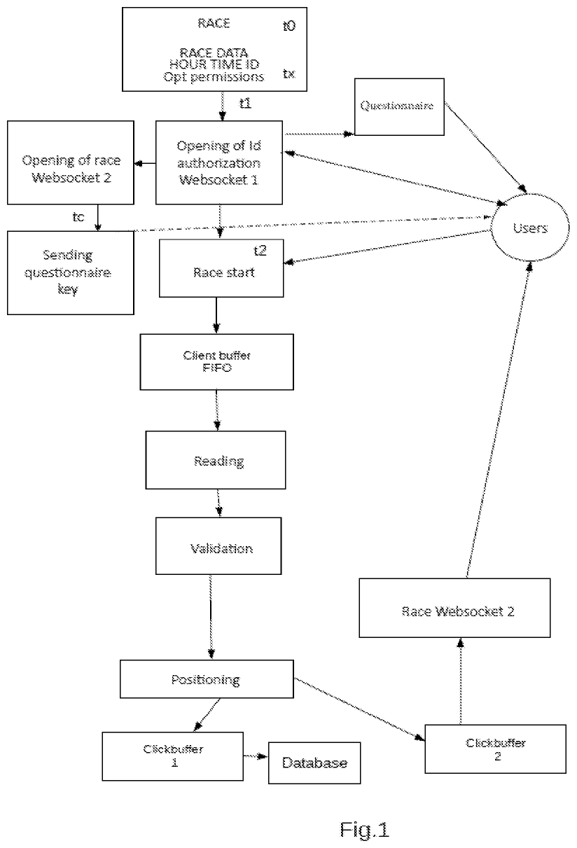

With reference, therefore, to FIG. 1 and to what has already been illustrated above, the fundamental steps for this method of regulation and distribution of goods and services are reported:

Race creation at time t0 with:
an identifier I or race name G;
a time/date of the start and end Time IF;
an accessibility time tx before the actual start of the race;
   optionally
definition of user permissions;
user access to the race at a time t1 where t1:t0<tx<t1<t2 and where t2 is the race start time.
opening of a first connection (authorization websocket) between the system and the participant, said websocket verifies the permissions for the specific race:
sending by the participant the identifier of the race (to confirm that they are participating in that race;
sending by the participant of an anonymous identification key (if any); if the checks are passed,
   authorises the client to open the race websocket;
sends the client (for example) the image and the question to be solved of the questionnaire, in encrypted format;
sending by the system through the open race websocket of a key to allow the electronic questionnaire to be clearly seen by the participating user at a time tc (t1<tc<t2);
start of the race at time t2 with exchange of information from the participant to the system and vice versa,
response and sending to the system of said questionnaire sent by the system to the participating user,
a structure called Client Buffer will collect the information sent by the participants through the race websocket and will be recorded/stored with a method known in the art as FIFO (first in-first out) to establish the ranking of the participants
reading and processing the information received by means of a specially defined “reader” structure,
Validation of information,
Definition of the placement list:
Sending the positioning results simultaneously to two clickbuffer (temporary data containment structures):
the first clickbuffer will provide the data to a database for the registration of the positioning available to the system,
the second clickbuffer by means of a second dedicated (race) websocket, will provide positioning information to each participant.
Note that said questionnaire is sent at any time (t1) with also (t1<<t2), as long as instead (tc≈<t2), i.e. tc is slightly inferior but close to t2 to guarantee the correctness of the sending to each participant in the race.

It is evident that the innovative method described by the present invention is able to brilliantly solve the aforementioned problems of the known art. It should be noted that variations in the steps of the method, addition of steps, variations in the computer implementation, means for its implementation are all aspects included in lawful variants of the present invention that maintain the objects thereof and are therefore protected by the present invention as better defined by the appended claims.

1. A method of regulation and distribution of goods and services distributed online comprising at least one or more computer systems and comprising at least the phases of:
PHASE 1:
Creation of a one-time race (t0), where a race means a procedure used to draw up the positioning for online purchases obtained by remote users who participate in said race being distinguished by:
an identifier (I) or race name (G);
a time/date of the start and end Time (IF);
characterized by the fact of having:
an accessibility time (tx) before the actual start (t2) and optionally:
definition of permits to participate that is: race without permits (race (X) or race with permits (Y);
in the event of a race with permits (Y), the participant will have an anonymous key previously communicated;
in the event of a race without permits, nothing else will be necessary.
PHASE 2:
user access to the race at a time (t1) where (t1:t0<tx<t1<t2) and where (t2) is the race start time.
opening of a first connection through an authorization websocket between said computer system and the participants;
said websocket verifies the permissions (PU) to the specific race comprising:
sending by a participant of the identifier (I) of the race (G) to the computer system (to confirm that you are participating in that race;
(optional)
sending by the participant of said anonymous identification key to the computer system in the event of a race (Y);
if the permissions are verified, the opening of a race websocket is authorized, after the time (tx) at the time (t1) then before the start of the race (t2);
opening of a connection between the computer system and the user called race websocket therefore before (t2), the connection being opened in advance of the sending of the actual race information, to minimize any discrimination due to network speed and the like, ensuring simultaneous reception of all information relating to the user.

2. The method of regulation and distribution of goods and services according to claim 1, wherein said method further comprising the steps of:
the sending by the computer system of an electronic questionnaire to the participating user in an encrypted way that is not legible for the user at time (t1) in order to allow all users to receive the questionnaire before the start of the race at time (t2) so as not to overload the system; subsequently sending by the race websocket of a key to decrypt the electronic questionnaire at the time (t1<tc<t2);
PHASE C start of the race at time (t2):
The user who answered the questionnaire sends it to the computer system;
a structure called Client Buffer will collect the information sent by the participants through the race websocket and will be recorded/stored with a known method (e.g. FIFO) to establish the ranking of the participants;
the computer system reads and processes the information (identifying of each user) and subsequently;
validation of the information or verifies that the data are complete with respect to the required requirements;
definition of the positioning list based on FIFO;
sending the positioning results simultaneously to two clickbuffer (temporary data containment structures):
the first clickbuffer will provide the data to a database for the registration of the positioning available to the system,
the second clickbuffer by means of a second dedicated (race) websocket, will provide positioning information to each participant by dividing the data flow making the management of the race fast.

3. Method of regulation and distribution of goods and services according to the preceding claims in which said questionnaire is sent at any time (t1) with also (t1<<t2), provided that instead (tc≈<t2), or tc is slightly inferior but close to t2 to ensure the correctness of the sending at each participant in the race.

4. Method of regulation and distribution of goods and services according to the preceding claims, wherein said questionnaire may comprise simple questions (e.g. a mathematical/logical/visual questionnaire).
